(19) United States
(12) Patent Application Publication
(10) Pub. No.: US 2009/0317312 A1
(43) Pub. Date: Dec. 24, 2009

(54) Frangible seal for capsules utilized to dispense chemicals into swimming pools, spas, and other pools of water

(76) Inventors: Shawn Mikuski, Lakewood, NJ (US); Larry Ruizzo, Lakewood, NJ (US)

Correspondence Address: CLIFFORD G. FRAYNE, 136 DRUM POINT RD, SUITE 7A, BRICK, NJ, 08723, US

(21) Appl. No.: 12/456,535

(22) Filed: Jun. 18, 2009

Related U.S. Application Data
(60) Provisional application No. 61/132,475, filed on Jun. 20, 2008.

(51) Int. Cl. C02F 1/68

(52) U.S. Cl. 422/265

(57) ABSTRACT

The present invention relates to swimming pools, spas, and other pools of standing water, and in particular to a dispensing unit in the form of a capsule which is formed with a novel frangible seal which seal is puncturable by a blunt puncture device which allows for the improved time release of the chemicals within the capsule once the capsule is positioned in the skimmer of a pool, spa, or pool of standing water.

### RELATED APPLICATIONS

Applicant claims the benefit of provisional application Ser. No. 61/132,475, filed Jun. 20, 2008.

### BACKGROUND OF THE INVENTION

1. Field of the Invention

The present invention relates to swimming pools, spas, and other pools of standing water, and in particular to a dispensing unit and improved seal that distributes a chemical solution into the swimming pool, spa, or other pool of water.

2. Description of the Prior Art

This invention relates to water quality, and more particularly to methods and apparatus for feeding controlled amounts of chemicals into swimming pools, hot tubs, spas, cooling towers and other standing water ponds.

In home swimming pools and in newly popular hot tubs, spas, and other water pools, it is almost always necessary to filter and recirculate the water and to add certain chemicals, such as organic flocculating agents, algaecides, etc., which greatly improved the effectiveness of the filters in removing impurities.

Still further, chlorination is undertaken in swimming pools, hot tubs and spas in order to improve the quality of water and in some instances, chelating agents are positioned in the water to prevent the formation of scale in boilers.

In large public and commercial systems, apparatus know as “feeders” are used to meter predetermined amounts of such chemicals into the water. This is practical from the stand point of large industrial and public treatment facilities, but the necessary capital investment for such equipment makes it impractical for a home pool, spa, hot tub or small cooling tower.

It has been discovered that many of the desired water treatment chemicals needed for relatively small swimming pools, hot tubs and spas, can be packaged and shipped in closed and sealed plastic spheres of handy size. In use, one or more apertures are punctured in the shell of the sphere and the chemical enclosed is dropped in the water, most often in the skimmer of the pool or spa. It has further been discovered that the motion of the water and of the sphere in the water can produce the desired rate of chemical feeding. A dispenser of this type and suitable for dispensing Applicant's formulation is disclosed by Etani in U.S. Pat. No. 4,519,814, which is incorporated by reference.

In one embodiment, the capsule is used to add alum to the water of a backyard swimming pool. Dropped into the skimmer basket it introduces alum at a substantially constant rate proportional to the rate of flow and independent of the amount of undissolved alum remaining in the capsule. Although at any instant the dispensing rate from the capsule will depend upon the position of the tiny apertures relative to the flow, the positioned effect is eliminated, on the average, because of the movement of the capsule. This type of chemical feeding provides a cleaner pool and a more economical method of introducing the chemicals into the pool.

Capsules of the type described disburse the chemicals through a plurality of puncture holes in the shell of the capsule, the puncture holes being made by a push-pin having a relatively sharp pointed end, the push-pin being supplied with the capsule in the packaging and at the point of sale.

The capsules of the type previously described in which puncture holes are made with a push pin or other sharp instrument, are designed to release their chemical contents over a period of days. In some instances depending upon the chemical to be released, it is preferable that the release take place over several days. In other instances, the chemicals can be released more quickly. One problem associated with the capsules described in the prior art is that they occupy space within the skimmer basket and in many instances, home pools and spas utilize chlorine tablets for the chlorination of the pool, these tablets also occupying space within the skimmer basket. Therefore a capsule which requires several days to release its chemical contents interferes with the chlorination of the pool. Therefore there is need for an improved capsule with a seal and a release mechanism which will allow the chemical content of the capsule to be released into the pool based upon the motion of the water in the pool within a period of several hours as opposed to days.

### OBJECTS OF THE INVENTION

An object of the present invention is to provide for a novel delivery system for water treatment chemicals for swimming pools, hot tubs and spas.

Another object of the present invention is to provide for a novel delivery system in the form of a safe container for storage, shipment and introduction of water chemicals that both simple and safe.

Still another object of the present invention is to provide for a novel delivery system for a chemical solution for a swimming pool, hot tub or spa, which has an improved frangible seal which is puncturable with a blunt puncturing device.

A still further object of the present invention is to provide for a novel delivery system for a chemical solution to a swimming pool, hot tub, or spa, which allows for the delivery of the chemical contents over a period of hours, and thus not occupying a skimmer basket unduly or interfering with the chlorination of the pool.

### SUMMARY OF THE INVENTION

The present invention relates to swimming pools, spas, and other pools of standing water, and in particular to a dispensing unit in the form of a capsule which is formed with a novel frangible seal which seal is puncturable by a blunt puncture device which allows for the improved time release of the chemicals within the capsule once the capsule is positioned in the skimmer of a pool, spa, or pool of standing water.

### BRIEF DESCRIPTION OF THE DRAWINGS

These and other objects of the present invention will become apparent, particularly when taken in light of the following illustrations wherein:

FIG. 1 is a cross-sectional view of a dispensing container of the prior art;

FIG. 2 is a cross-sectional view of a dispensing container of the present invention;

FIG. 3 is a close up top plan view of the seal or plug of the dispensing container of the present invention;

FIG. 4 is a cross-sectional view of the seal or plug along Plane 4-4 of FIG. 3;

FIG. 5 is a side view of a puncture instrument cooperative with the improved seal of the present invention; and

FIG. 6 is a perspective view of the puncture instrument of the present invention.

### DETAILED DESCRIPTION OF THE INVENTION

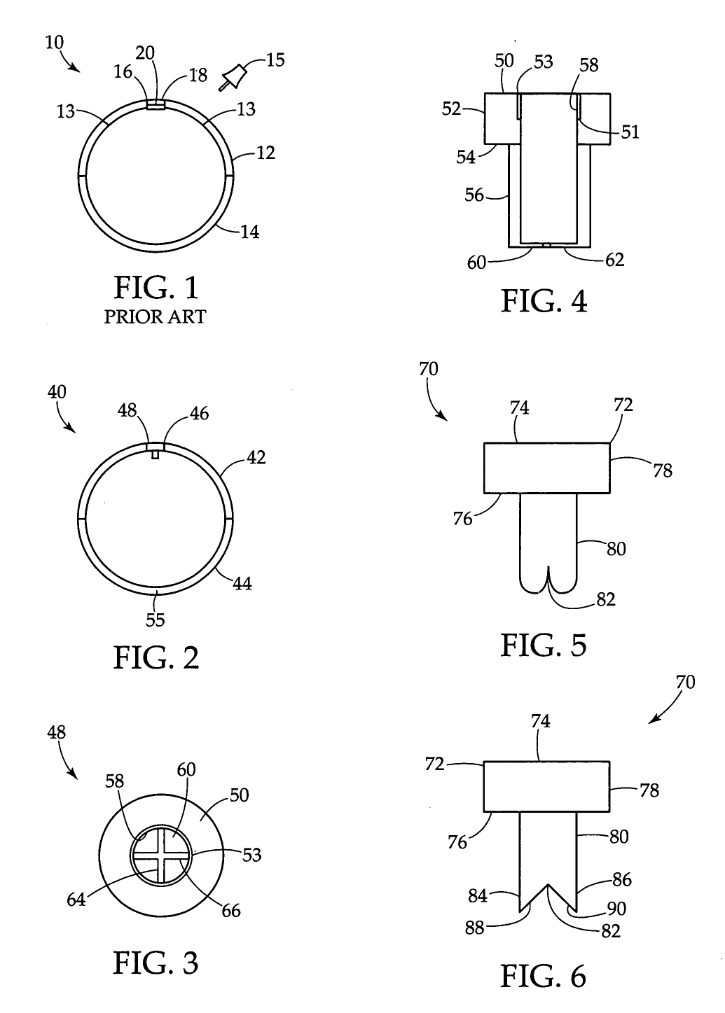

FIG. 1 is representative of the prior art dispensing container for chemicals for pools or spas. The dispenser or capsule 10 comprises two plastic hemispheres 12 and 14 which are joined together. The manner of joining can be by means of cement or adhesive or the hemispheres 12 and 14 can be molded or formed with complimentary flanges, which flanges can be secured by ultrasonic welding. Hemisphere 12 has a filling aperture 16 which is closed by a plug 18. Plug 18 is formed with a buoyant portion 20. The prior art required that a number of small holes or apertures be formed in hemisphere 12 to release the contents. The location of these small holes were identified by indicia 13 on hemisphere 12 and the actual capsule was sold or marketed with a push pin 15 contained in the packaging, push pin 15 to be utilized to form the puncture holes or apertures at the indicia points prior to insertion of the capsule into the body of water.

Capsules of this design would be placed in the skimmer of the pool, hot tub or spa, and would release the contents of the capsule responsive to the movement of the water based on the number of people using the pool, hot tub or spa over a period of days. In many instances it is not desirable that the capsule occupies space in skimmer basket for such a long time, in that it may interfere with other pool requirements, such as chlorination. Therefore, there is a need for a capsule which can dispense its chemical contents in a time release manner, but much quicker that that of the prior art.

FIG. 2 is a perspective view of the dispensing container of the present invention. The dispensing container or capsule 40 is formed of two hemispheres 42 and 44 which are joined together and secured by any suitable method, including those identified in the prior art. Hemisphere 42 is formed with a filling aperture 46 which is secured by a plug 48. Plug 48 serves not only to seal the chemical within the capsule 40, but it also serves as the release mechanism for the release of the chemical into the body of water.

FIG. 3 is a close up top plan view of plug 48 of dispensing container 40 and FIG. 4 is a side cross-sectional view of plug 48 and the puncture instrument. Seal 48 is formed with an annular upper surface 50, a circumferential side wall 52, terminating in an inwardly depending shoulder 54 and a depending cylindrical body member 56, the circumference of which is complimentary with the filling aperture 46 on hemisphere 42. The configuration of plug 48 defines an axial bore 58 extending from annular upper surface 50 to a frangible bottom wall 60 defining the terminus 62 of axial bore 58. Bottom wall 60 is molded or formed with two intersecting embossed ribs 64 and 66 which are perpendicular to each other and extend across the bottom wall 60 of axial bore 58. Ribs 64 and 66 are cooperative with the puncture instrument as will be described hereafter and provide a degree of rigidity to frangible bottomw all 60 during transport and storage.

Seal 48 is also formed with an annular shoulder portion 51 about the upper portion of axial bore 58 in order to accommodate a circumferential weight ring 53 which is pressure fit into the axial bore 58 and sits on shoulder 51. Weight ring 53 maintains seal 48 and axial bore 58 in a downward, submerged position once the frangible bottom wall 60 has been breached and the capsule has been placed into a skimmer. The submergence of the axial bore 58 insures the discharge of the chemical bet it liquid or solid into the pool under the influence of wave motion. Still further, the evacuation of the chemicals contained in the capsule can be assisted by providing for a pin hole puncture 55 in hemisphere 44, approximately 180 degrees opposite of the seal 48.

FIG. 5 is a side view of the puncture instrument 70 of the present invention, and FIG. 6 is a perspective view of the puncture instrument 70. Puncture instrument 70 is of one piece integral construction preferably molded of PVC or ABS. The puncture instrument 70 has a finger pressure engageable upper end 72 having an upper surface 74 and lower surface 76 and a peripheral side wall 78. As illustrated in FIGS. 5 and 6, the finger pressure engageable upper end 72 is circular and has a centrally positioned cylindrical shaft 80 depending from lower surface 76. The terminus of cylindrical shaft 80 is formed with a V-cut 82 which results in two depending fingers 84 and 86 defined by an angled planar inner surface 88 and 90 and a semi-cylindrical outer surface. The length of depending cylindrical shaft 80 of puncture instrument 70 is slightly greater than the depth of the axial bore 58 in plug 48. The diameter of depending cylindrical shaft 80 is slightly less than the diameter of the axial bore 58 in plug 48.

The opposing fingers 84 and 86 of puncture instrument 70 and their elliptical periphery present no sharp, pointed ends such as the puncture instrument of the prior art which could cause injury if left unattended. Still further, the fingers 84 and 86 of plunger instrument 70 are cooperative with the bottom wall 60 of plug 48 which serves as the manner of dispensing the liquid contained in the capsule 40.

Puncture instrument 70 is inserted into axial bore 58 of plug 48 and the opposing fingers 84 and 86 will contact the bottom wall 60. If the two opposing fingers come in contact with the embossed ribs 64 and 66 formed in bottom wall 60 of plug 48, they will be unable to puncture the lower wall. However, because of their elliptical edges, the fingers 84 and 86 are designed to slide off of the embossed ribs 64 and 66 if contacted so as to rest firmly against the frangible portion of the bottom wall 60 which consists of the four quadrants defined by the intersecting embossed ribs 64 and 66. When the plunger instrument 70 finds itself in this position with the opposing fingers in contact with the quadrant surface of the bottom wall 60 of axial bore 50, a firm but slight pressure applied to the finger pressure end 72 of plunger instrument 70 will cause the opposing fingers to penetrate or rupture the frangible bottom wall 60.

The capsule 40 is then placed into a pool of water such as the skimmer of a pool, and become subject to the wave motion of the pool, the chemicals contained within the capsule will be released due to the weight ring 53 positioning the axial bore 58 of seal 48 vertically downwardly in a submerged orientation. Since the size of the hole is greater than that of the apertures utilized in the prior art, the chemicals contained within the capsule will be time released, but the time release will take place over a period of hours as opposed to days, thereby allowing chlorination tablets to be placed in the skimmer when required. Still further, to improved the release of the chemicals, a small aperture 55 may be made in the spherical capsule opposite the seal to improve the flow of chemicals.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

We claim:

1. An improved seal for chemical dispensing capsules for swimming pools and spas wherein said capsule is spherical in shape having neutral buoyancy and is filled with a water soluble chemical by means of a feeding aperture, said feeding aperture secured by a seal;
wherein said improved seal incorporates a frangible portion for the dispensing of said water soluble chemical, said improved seal comprising a frangible membrane, said frangible membrane recessed in a bore from an outer surface of said improved seal to prevent unintended puncture, said frangible membrane punctured by means of a plunger member having a finger engageable end and a fork end comprised of at least two forks in spaced apart angled relationship for contact and puncture of said frangible membrane thereby forming a throughbore for release of said water soluble chemical.

2. The improved seal for chemical dispensing capsules for swimming pools and spas in accordance with claim 1 wherein said frangible membrane is reinforced with embossed intersecting ribs for strength in order to prevent the unintended fracture of said membrane during transport and storage.

3. The improved seal for chemical dispensing capsules for swimming pools and spas in accordance with claim 1 wherein said seal is formed with a bore, terminating with said frangible membrane, said bore having an annular shoulder for receipt of a weighted ring member orienting said throughbore of said seal formed after puncture of said frangible membrane in a vertical downwardly submerged orientation for release of said water soluble chemical.

4. The improved seal for chemical dispensing capsules for swimming pools and spas in accordance with claim 1 wherein said plunger member is formed of a planar finger engageable end having a shaft member perpendicular thereto, said shaft member ending in a pair of elliptically-shaped, spaced apart fork members, said shaft member having a diameter complimentary with a diameter of said bore in said improved seal.

5. The improved seal for chemical dispensing capsules for swimming pools and spas in accordance with claim 1 wherein said dispensing of said water soluble chemical through said throughbore formed in said seal is enhanced by forming a pin hole aperture in said chemical dispensing capsule in 180 degree relationship to said seal.
